(19) United States
(12) Patent Application Publication
(10) Pub. No.: US 2021/0135583 A1
(43) Pub. Date: May 6, 2021

(54) ISOLATED BIDIRECTIONAL DC-DC CONVERTER DEVICE AND CONTROL METHOD FOR ISOLATED BIDIRECTIONAL DC-DC CONVERTER CIRCUIT

(71) Applicant: OMRON Corporation, Kyoto-shi, KYOTO (JP)

(72) Inventors: Makoto OHASHI, Uji-shi (JP); Yoshihiko YAMAGUCHI, Otsu-shi (JP); Takeo NISHIKAWA, Kyoto-shi (JP); Takanori ISHII, Uji-shi (JP)

(73) Assignee: OMRON Corporation, Kyoto-shi, KYOTO (JP)

(21) Appl. No.: 16/638,775

(22) PCT Filed: Feb. 27, 2018
(86) PCT No.: PCT/JP2018/007223

§ 371 Date: Feb. 13, 2020

(30) Foreign Application Priority Data
Sep. 21, 2017 (JP) 2017-181142

(51) Int. Cl. H02M 3/335; H02M 7/219; H02M 7/5387; H02M 1/32

(52) U.S. Cl. CPC H02M 3/33584; H02M 7/219; H02M 2001/0003; H02M 1/32; H02M 2001/327; H02M 7/5387

(57) ABSTRACT

An isolated bidirectional DC-DC converter device includes a first full-bridge inverter and a second full-bridge inverter circuit connected via a transformer; the second full-bridge inverter circuit including high-side switching elements and low-side switching elements; and a control unit configured to repeatedly execute an input-side control and an output-side control when boosting the input voltage to the first full-bridge inverter circuit; the control unit selectively executes any of a first control and a second control as the output-side control. The first control maintains the high-side switching elements in the OFF state while alternating each of the low-side switching elements between the ON and OFF states; and the second control maintains the low-side switching elements in the OFF state while alternating each of the high-side switching element between the ON and OFF states.

### FIELD

The present invention relates to an isolated bidirectional DC-DC converter device and a control method for an isolated bidirectional DC-DC converter circuit.

### BACKGROUND

The circuit illustrated in FIG. 1 is one known configuration of an isolated bidirectional DC-DC converter circuit; that is, a circuit where two full-bridge inverter circuits 11, 12 are connected via a transformer TR.

The full bridge inverter circuit 11 side in the isolated bidirectional DC-DC converter circuit may be made to perform a boost operation as a primary side; traditionally in this case, the switches (switching elements) are set to ON or OFF as illustrated in FIG. 2. FIG. 2 illustrates a time variance pattern for a current IL flowing in an inductor L provided between the full bridge inverter circuit 11 and the transformer TR.

That is, when the full bridge inverter circuit 11 is made to perform a boost operation as the primary side of the above isolated bidirectional DC-DC converter circuit, only the low-side switches Q7 and Q8 are controlled to ON and OFF instead of the switches Q5, Q6 among the secondary side switches Q5−Q8. This is similar to the operation in an isolated unidirectional DC-DC converter device provided with a diode (see, for example, Patent Document 1).

To maintain the temperature of the low-side switches Q7 and Q8 at or below a permissible temperature, traditional control methods must restrict the conditions under which the isolated bidirectional DC-DC converter circuit can continue to operate to avoid excessive increases in the temperature of the low-side switches Q7 and Q8.

### RELATED ART DOCUMENTS

### Patent Documents

[Patent Document 1] Japanese Patent Publication Number 5530401

### SUMMARY

### Technical Problem

However, consider the isolated bidirectional DC-DC converter circuit provided with a full-bridge inverter circuit made up of four bidirectional switching elements; traditional control (described later in detail) of this circuit during a boost operation creates a temperature difference between the bidirectional switching elements in the aforementioned full-bridge inverter circuit on the secondary side.

In light of the foregoing, embodiments of the present invention make it possible to minimize increases in the temperature of the switching elements on the secondary side when performing a boost operation in an isolated bidirectional DC-DC converter circuit that includes two full-bridge inverter circuits connected via a transformer.

### Solution to Problem

To achieve these aims, an isolated bidirectional DC-DC converter device according to embodiments of the present invention is provided with a first full-bridge inverter circuit configured to include first through fourth switching elements; a second full-bridge inverter circuit connected to the first full-bridge inverter circuit via a transformer; the second full-bridge inverter circuit including a fifth switching element and a sixth switching element which are high-side switching elements, and a seventh switching element and an eighth switching element which are low-side switching elements; and a control unit configured to repeatedly execute an input-side control and an output-side control when boosting the input voltage to the first full-bridge inverter circuit, where the input-side control actuates the switching elements in the first full-bridge inverter circuit and the output-side control actuates the fifth through eighth switching elements in the second full-bridge inverter circuit synchronously with each input-side control. The control unit in an isolated bidirectional DC-DC converter device according to embodiments of the present invention may selectively execute any of a first control and a second control as the output-side control where the first control maintains the fifth switching element and the sixth switching element in the OFF state while alternating the seventh switching element and the eighth switching element between the ON and OFF states; and the second control maintains the seventh switching element and the eighth switching element in the OFF state while alternating the sixth switching element and the fifth switching element between the ON and OFF states.

That is, the control unit in an isolated bidirectional DC-DC converter device according to embodiments of the present invention may selectively execute any of a first control or a second control when boosting the input voltage to a first full-bridge inverter circuit in an isolated bidirectional DC-DC converter circuit (made up of a first full-bridge inverter circuit, a second full-bridge inverter circuit, and a transformer) where the first control actuates the ON and OFF states of the fifth and sixth switching elements (high-side switching elements or low-side switching elements) in the second full-bridge inverter circuit, and the second control actuates the ON and OFF states of the seventh and eighth switching elements (low-side switching elements or high-side switching elements). Therefore, an isolated bidirectional DC-DC converter device according to embodiments of the present invention is capable of minimizing an increase in the temperature of the low-side switching elements when boosting the input voltage to the first full-bridge inverter circuit to the extent that the high-side switching elements (the seventh and eighth switching elements or the fifth and sixth switching element) are actuated to the ON and OFF states.

The second full-bridge inverter circuit in the isolated bidirectional DC-DC converter device according to embodiments of the present invention may include only fifth through eighth switching elements, or may use unidirectional switching elements in inverse-parallel connection to serve as each of the fifth through eighth switching elements, or may use bidirectional switching elements in parallel connection to serve as each of the fifth through eighth switching elements.

If an isolated bidirectional DC-DC converter device according to embodiments of the present invention adopt a configuration where “ the control unit alternates between executing the first control and the second control as the output-side control” it is possible for the low-side switching elements and the high-side switching elements to generally be substantially the same temperature during a boost operation.

However, with the above configuration in some cases the temperature of the low-side switching elements and the high-side switching elements may not be substantially the same where the characteristics of each of the switching elements varies, or where the heat dissipation environment for switching elements differ. It is possible to obtain an isolated bidirectional DC-DC converter device where the low-side switching elements and the high-side switching elements are substantially the same temperature during a boost operation by adopting a configuration where “the control unit acquires a temperature T1 of the seventh and eighth switching elements, and a temperature T2 of the fifth and sixth switching elements; and when T1−T2 is greater than or equal to a first predetermined value greater than or equal to zero, the control unit increases a first control execution rate which is a proportion for which the first control is performed as the output-side control; and when T1−T2 is less than a second predetermined value that is less than or equal to zero, the control unit decreases said first control execution rate”.

A control method for an isolated bidirectional DC-DC converter circuit including a first full-bridge inverter circuit that includes first through fourth switching elements and a second full-bridge inverter circuit connected to the first full-bridge inverter circuit via a transformer, the second full-bridge inverter circuit including a fifth switching element and sixth switching element which are high-side switching elements, and a seventh switching element and an eighth switching element which are low-side switching elements, and the control method according to embodiments of the invention involving: periodically executing an input-side control and an output-side control when boosting the input voltage to the first full-bridge inverter circuit, where the input-side control actuates the switching elements in the first full-bridge inverter circuit, and the output-side control actuates the fifth through eighth switching elements in the second full-bridge inverter circuit; and selectively executing any of a first control and a second control as the output-side control where the first control maintains the fifth switching element and the sixth switching element in the OFF state while alternating the seventh switching element and the eighth switching element between ON and OFF states, and the second control maintains the seventh switching element and the eighth switching element in the OFF state while alternating the sixth switching element and the fifth switching element between the ON and OFF states.

That is, the control method for an isolated bidirectional DC-DC converter device according to embodiments of the present invention may selectively execute any of a first control or a second control when boosting the input voltage to a first full-bridge inverter circuit in an isolated bidirectional DC-DC converter circuit where the first control actuates the ON and OFF states of the fifth and sixth switching elements (high-side switching elements or low-side switching elements) in the second full-bridge inverter circuit, and the second control actuates the ON and OFF states of the seventh and eighth switching elements (the low-side switching elements or the high-side switching elements). Therefore, a control method for an isolated bidirectional DC-DC converter circuit according to embodiments of the present invention is capable of minimizing an increase in the temperature of the low-side switching elements during the boost operation to the extent that the high-side switching elements (the seventh and eighth switching elements or the fifth and sixth switching element) are actuated to the ON and OFF states.

An isolated bidirectional DC-DC converter device according to embodiments of the present invention is provided with a first full-bridge inverter circuit configured to include first through fourth switching elements; a second full-bridge inverter circuit having a first leg and a second leg and connected to the first full-bridge inverter circuit via a transformer; the second full-bridge inverter circuit including a fifth bidirectional switching element and a sixth bidirectional switching element which are high-side switching elements, and a seventh bidirectional switching element and an eighth bidirectional switching element which are low-side switching elements; and a control unit configured to repeatedly execute an input-side control and an output-side control when boosting the input voltage to the first full-bridge inverter circuit, where the input-side control actuates the switching elements in the first full-bridge inverter circuit and the output-side control actuates the fifth through eighth switching elements in the second full-bridge inverter circuit synchronously with each input-side control. The control unit in an isolated bidirectional DC-DC converter device according to a second embodiment is configured to selectively execute any of a first control and a second control as the output-side control, where the first control actuates the fifth through eighth bidirectional switching elements so that when a current circulates in the second full-bridge inverter circuit said current passes through the seventh bidirectional switching element and the eighth bidirectional switching element to thereby rectify the output of the transformer; and the second control actuates the fifth through eighth bidirectional switching elements so that when a current circulates in the second full-bridge inverter circuit, said current passes through the fifth bidirectional switching element and the sixth bidirectional switching element to rectify the output of the transformer.

That is, in the isolated bidirectional DC-DC converter device according to the second embodiment of the present invention, any of a first control and a second control are selectively executed when boosting the input voltage to the first full-bridge inverter circuit in the isolated bidirectional DC-DC converter circuit (a first full-bridge inverter circuit, second full-bridge inverter circuit, and transformer), where the first control “actuates the fifth through eighth bidirectional switching elements so that when a current circulates in the second full-bridge inverter circuit said current passes through the seventh bidirectional switching element and the eighth bidirectional switching element to thereby rectify the output of the transformer” and the second control “actuates the fifth through eighth bidirectional switching elements so that when a current circulates in the second full-bridge inverter circuit, said current passes through the fifth bidirectional switching element and the sixth bidirectional switching element to rectify the output of the transformer”. An isolated bidirectional DC-DC converter device configured as above described is capable of minimizing an increase in temperature of the low-side switching elements to the extent that the second control is performed (i.e., insofar as the current loops through the seventh and eighth bidirectional switching elements which are the high-side switching elements, and not in the fifth and sixth bidirectional switching elements which are the low-side switching elements) since the second full-bridge inverter circuit in an isolated bidirectional DC-DC converter circuit configured as above described would traditionally be made to repeat the first control.

A control method for an isolated bidirectional DC-DC converter circuit according to a second embodiment with the isolated bidirectional DC-DC converter circuit including a first full-bridge inverter circuit that includes first through fourth switching elements and a second full-bridge inverter circuit having a first leg and a second leg and connected to the first full-bridge inverter circuit via a transformer, the second full-bridge inverter circuit including a fifth switching element and sixth switching element which are high-side switching elements, and a seventh switching element and an eighth switching element which are low-side switching elements, and the control method including: periodically executing an input-side control and an output-side control when boosting the input voltage to the first full bridge inverter circuit, where the input-side control actuates the switching elements in the first full-bridge inverter circuit, and the output-side control actuates the fifth through eighth bidirectional switching elements in the second full bridge inverter circuit; and selectively execute any of a first control and a second control as the output-side control, where the first control actuates the fifth through eighth bidirectional switching elements so that when a current circulates through the second full-bridge inverter circuit said current passes through the seventh bidirectional switching element and the eighth bidirectional switching element to thereby rectify the output of the transformer; and the second control actuates the fifth through eighth bidirectional switching elements so that when a current circulates in the second full-bridge inverter circuit, said current passes through the fifth bidirectional switching elements to rectify the output of the transformer.

That is, in control method for the isolated bidirectional DC-DC converter circuit (a first full-bridge inverter circuit, second full-bridge inverter circuit, and transformer) according to the second embodiment of the present invention, any of a first control and a second control are selectively executed when boosting the input voltage to the first full-bridge inverter circuit, where the first control “actuates the fifth through eighth bidirectional switching elements so that when a current circulates in the second full-bridge inverter circuit said current passes through the seventh bidirectional switching element and the eighth bidirectional switching element to thereby rectify the output of the transformer” and the second control “actuates the fifth through eighth bidirectional switching elements so that when a current circulates in the second full-bridge inverter circuit, said current passes through the fifth bidirectional switching element and the sixth bidirectional switching element to rectify the output of the transformer”. Therefore, similarly to the isolated bidirectional DC-DC converter device of the above described second embodiment of the present invention, the control method is capable of minimizing an increase in the temperature of the low-side switching elements by as much as the second control is performed.

### Effects

Embodiments of the present invention make it possible to minimize increases in the temperature of the switching elements on the secondary side when performing a boost operation in an isolated bidirectional DC-DC converter circuit that includes two full-bridge inverter circuits connected via a transformer.

### BRIEF DESCRIPTION OF THE DRAWINGS

FIG. 1 is a circuit diagram of an isolated bidirectional DC-DC converter circuit where two full-bridge inverter circuits are connected via a transformer TR;

FIG. 2 is a timing chart for describing the control of the switching elements when the isolated bidirectional DC-DC converter circuit in FIG. 1 performs a boost operation;

FIG. 3 is a schematic view illustrating an isolated bidirectional DC-DC converter device according to a first embodiment;

FIG. 4 is a timing chart for describing the details of the control of the switching elements performed by the control unit in the isolated bidirectional DC-DC converter device of the first embodiment;

FIG. 5 is for describing the current paths in the isolated bidirectional DC-DC converter circuit during each state created through control by the control unit;

FIG. 6 is a schematic view illustrating an isolated bidirectional DC-DC converter device according to a second embodiment;

FIG. 7 depicts the flow of an execution rate adjustment process carried out by the control unit in the isolated bidirectional DC-DC converter device according to the second embodiment;

FIG. 8 is a schematic view illustrating an isolated bidirectional DC-DC converter device according to a third embodiment;

FIGS. 9A, 9B, 9C, 9D are current path diagrams for describing the details of the control traditionally performed by an isolated bidirectional DC-DC converter circuit provided with a second full-bridge inverter circuit that is configured from four bidirectional switching elements;

FIG. 10 is a table for describing the change of ON and OFF states of the bidirectional switching elements in the second full-bridge inverter circuit according to the traditional control method;

FIG. 11 illustrates current path diagrams for describing the details of controlling the second full-bridge inverter circuit in the isolated bidirectional DC-DC converter device according to the third embodiment;

FIG. 12 is a table for describing the ON and OFF states of the bidirectional switching elements in the second full-bridge inverter circuit for each of the states depicted in FIG. 11; and

FIG. 13 is for describing a possible modification to the isolated bidirectional DC-DC converter device according to the first and second embodiments.

### DETAILED DESCRIPTION

Embodiments of the present invention are described in detail with reference to the drawings. Note that the embodiments described herein are merely examples and the present invention is not limited to the configurations in these embodiments.

### First Embodiment

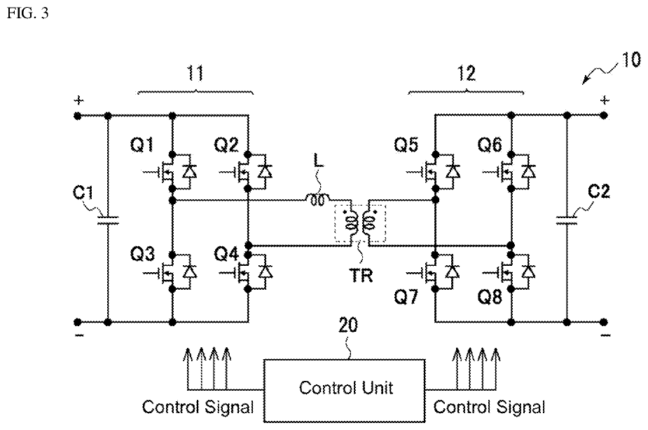

FIG. 3 is a schematic view illustrating an isolated bidirectional DC-DC converter device according to a first embodiment.

An isolated bidirectional DC-DC converter device (also “converter device” below) according to the embodiment is configured to perform bidirectional DC to DC conversion and is equipped with an isolated bidirectional DC-DC converter circuit 10 and a control unit 20.

The isolated bidirectional DC-DC converter circuit 10 provided to the converter device includes a first full-bridge inverter circuit 11 assembled from switching elements Q1−Q4 (MOSFETs, in this embodiment) and a second full-bridge inverter circuit 12 assembled from switching elements Q5−Q8; the first full-bridge inverter circuit 11 and the second full-bridge inverter circuit 1 are connected via a transformer TR. The switching elements Q1, Q2, Q5, and Q6 are the high-side switching elements and the switching elements Q3, Q4, Q7, and Q8 are the low-side switching elements.

As illustrated in FIG. 3, the first full-bridge inverter circuit 11 and the transformer TR in the isolated bidirectional DC-DC converter circuit 10 are connected via an inductor L. In addition, capacitors Cl, C2 are connected between the input and output terminals of the first full-bridge inverter circuit 11 and the input and output terminals of the second full-bridge inverter circuit 12 in the isolated bidirectional DC-DC converter circuit 10.

The control unit 20 actuates the on and off states of the switching elements Q1−Q8 in the isolated bidirectional DC-DC converter circuit 10 whereby the control unit causes the first full-bridge inverter circuit 11 side of the isolated bidirectional DC-DC converter circuit 10 to function as the primary side (input side) of a boost circuit and the second full-bridge inverter circuit 12 side to function as the primary side (input side) of a buck circuit. The control unit 20 is configured from a processor (such as a CPU, micro-controller, or the like) and the peripheral circuitry. The control unit 20 may also receive output from sensors (e.g., current sensor, voltage sensor; not shown) provided at various locations in the converter device.

A concrete example of the function of the control unit 20 is described below.

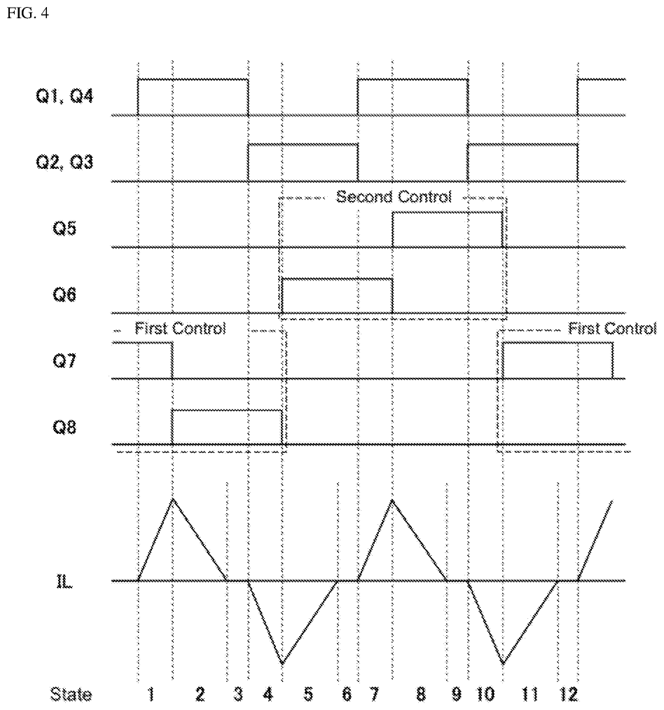

The control unit 20 is configured (programmed) to actuate the switching elements Q1−Q8 so that the switching elements Q1−Q8 perform as illustrated in FIG. 4 when the first full-bridge inverter circuit 11 is to boost the input voltage (i.e., when the isolated bidirectional DC-DC converter circuit 10 is performing a boost operation).

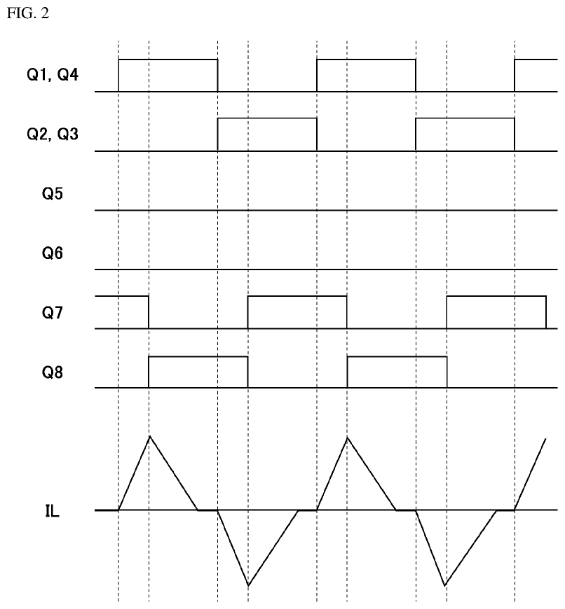

In other words, when boosting the input voltage to the first full-bridge inverter circuit 11 (also simply “when boosting” below), the control unit 20 actuates the switching elements Q1−Q4 in first full-bridge inverter circuit 11 which is the primary side, similarly to the existing method (FIG. 2).

The control unit 20 actuates the switching elements Q5−Q8 in the second full-bridge inverter circuit 12 which is the secondary side, differently from the existing method (FIG. 2). More specifically, the control unit 20 alternates between a first control that maintains the switching element Q5 and the switching element Q6 in an OFF state while alternately (sequentially) changing the switching element Q7 and the switching element Q8 between ON and OFF states, and a second control that maintains the switching element Q7 and the switching element Q8 in the OFF state while alternately changing the switching element Q6 and the switching element Q5 between ON and OFF states.

As is clear from comparing FIG. 4 and FIG. 2, the first control is similar to a control that periodically actuates the switching elements Q5, Q6 in the second full-bridge inverter circuit 12. Additionally, the second control is a modified version of the first control targeting the switching elements Q6, Q5 instead of the switching elements Q7, Q8.

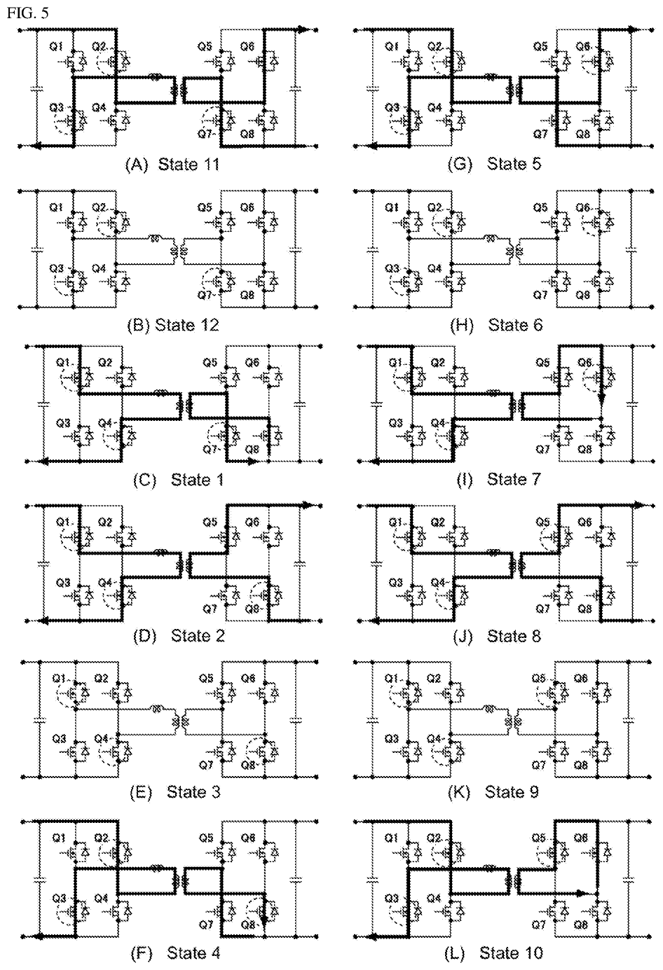

FIG. 5 depicts the current path in the isolated bidirectional DC-DC converter circuit 10 during states 1-12 created from the above-described first or second control of the switching elements Q5−Q8 and the control of the switching elements Q1−Q4. Note that the switching elements surrounded by dashed circles in FIG. 5 are in the ON state.

As is clear from FIG. 5, current flows through the secondary side along the same path in a State 5 created from the second control as the path in a state 11 created by from the first control (FIG. 5(A), FIG. 5(G)). Additionally, no current flows through the secondary side during a State 6 created by the second control similarly to a state 12 created by the first control (FIG. 5(B), FIG. 5(H)).

The current circulates in the secondary side during a State 7 created by the second control similarly to a State 1 created by the first control (FIG. 5(C), FIG. 5(I)). The current flows through the secondary side along the same path in a State 8 created from the second control as the current path in a State 2 created by the first control (FIG. 5(D), FIG. 5(J)). Additionally, no current flows through the secondary side during a State 9 created by the second control similarly to a State 3 created by the first control (FIG. 5(D), FIG. 5(K)).

The current circulates in the secondary side during a State 10 created by the second control similarly to a State 4 created by the first control (FIG. 5(E), FIG. 5(L)).

Accordingly, it is possible to cause the first full-bridge inverter circuit 11 side of the isolated bidirectional DC-DC converter circuit 10 to function as an input-side boost circuit by alternating the first control and the second control instead of repeatedly performing the first control (FIG. 2). The temperature of the switching elements Q5−Q8 increase roughly equally when alternating between the first control and the second control. Therefore, an isolated bidirectional DC-DC converter device according to the embodiment is capable of minimizing increases in the temperature of the low-side switching elements Q7 and Q8. As a result, the isolated bidirectional DC-DC converter device according to the embodiment may function under a wider range of conditions that make continuous operation possible (i.e., range of the boost ratio, and the like) compared to the traditional isolated bidirectional DC-DC converter device.

### Second Embodiment

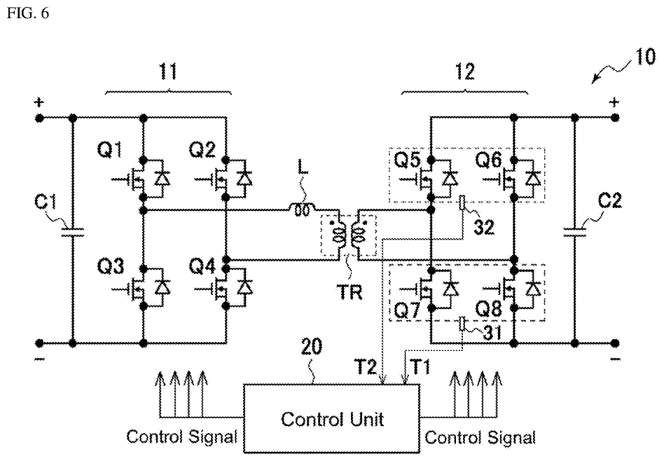

FIG. 6 is a schematic view illustrating an isolated bidirectional DC-DC converter device according to a second embodiment; the description below focuses on the differences with the above-described isolated bidirectional DC-DC converter device of the first embodiment to describe the configuration and function of an isolated bidirectional DC-DC converter device according to the second embodiment.

There are cases where the temperature of the low-side switching elements and the high-side switching elements are substantially equal when there are variations between the characteristics of the switching elements or when the switching elements are in different heat dissipation environments in the above-described isolated bidirectional DC-DC converter device according to the first embodiment (also “first converter device”, below). The isolated bidirectional DC-DC converter device according to the embodiment (also “second converter device” below) is a modification of the first converter device; more specifically, the second converter device is configured to ensure that the temperature of the low-side switching elements and the high-side switching elements are substantially the same even in the aforementioned kinds of cases.

As a concrete example, the hardware configuration of the second converter device is identical to that of the first converter device as illustrated in FIG. 6. However, the second converter device is provided with a temperature sensor 31 for measuring the temperature T1 of the low-side switching elements Q7 and Q8, and a temperature sensor 32 for measuring the temperature T2 of the high-side switching elements Q5 and Q6.

The control unit 20 in the second converter device also carries out the first control and the second control of the switching elements Q5−Q8 during boosting, similarly to the control unit 20 in the first converter device. However, the control unit 20 in the second converter device may also be given a function that changes the execution rate for the first control in response to the circumstances. Here, the execution rate of the first control is N1/(N1+N2), where in a given period the number of executions of the first control and the second control are N1 and N2 respectively.

More specifically, the control unit 20 in the second converter device is configured to carry out the first control R×K times and thereafter repeat the second control (1-R)×K times, where R is the execution rate of the first control. Note that K is a proportional coefficient for ensuring that R×K and (1-R)×K are whole numbers.

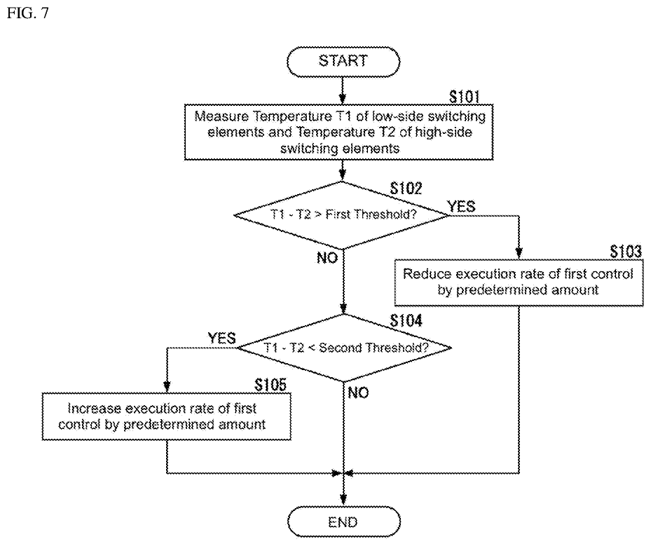

The control unit 20 is also configured to periodically perform the execution rate adjustment process depicted in FIG. 7 to modify (establish) an execution rate for the first control.

That is, during the execution rate adjustment process, the control unit 20 first acquires the temperature T1 of the low-side switching elements Q7 and Q8 and the temperature T2 of the high-side switching elements Q5 and Q6 from the temperature sensors 31 and 32 (step S101).

Next, the control unit 20 determines whether the condition that T1 minus T2 is greater than a first threshold is satisfied (step S102). The first threshold is a positive value determined in advance as the lower limit value of the difference in temperature (i.e., T1−T2) that causes an increase in the high-side switching elements Q5 and Q6.

The control unit 20 reduces the execution rate of the first control by a predetermined amount (step S103) when the condition that T1 minus T2 is greater than a first threshold is satisfied. The processing in step S103 may be to reduce the execution rate for the first control by a single degree. The control unit 20 which has completed the processing in step S103, then terminates the execution rate adjustment process and actuates the switching elements Q5−Q8 with the post-adjustment execution rate for the first control.

If the condition that T1 minus T2 is greater than a first threshold is not satisfied (No, at step S102), the control unit 20 determines whether or not the condition that T1 minus T2 is less than a second threshold is satisfied (step S104). The second threshold is a negative value determined in advance as the upper limit value of the difference in temperature (i.e., T1−T2) that causes an increase in the low-side switching elements Q7 and Q8.

If the condition that T1 minus T2 is less than the second threshold is satisfied (Yes, step S104), the control unit 20 increases the execution rate of the first control by a predetermined amount (step S105). The processing in step S105 may be to increase the execution rate of the first control by a single degree. The control unit 20 terminates the execution rate adjustment process and actuates the switching elements Q5−Q8 with the post-adjustment execution rate for the first control.

If the condition that T1 minus T2 is less than the second threshold is not satisfied (No, step S104), the control unit 20 terminates the execution rate adjustment process without modifying the execution rate of the first control. That is, in this case, the control unit 20 continues to actuate the switching elements Q5−Q8 with the same execution rate being used until that point.

As is clear from the above description, the isolated bidirectional DC-DC converter device according to this embodiment maintains the value of the temperature difference “T1−T2” between the low-side switching elements and the high-side switching elements from the second threshold to the first threshold. Therefore, an isolated bidirectional DC-DC converter device according to the embodiment is capable of ensuring the temperature of the low-side switching elements and the high-side switching elements are substantially equal even when there are variations between the characteristics of the switching elements or when the switching elements are in a different heat dissipation environments.

### Third Embodiment

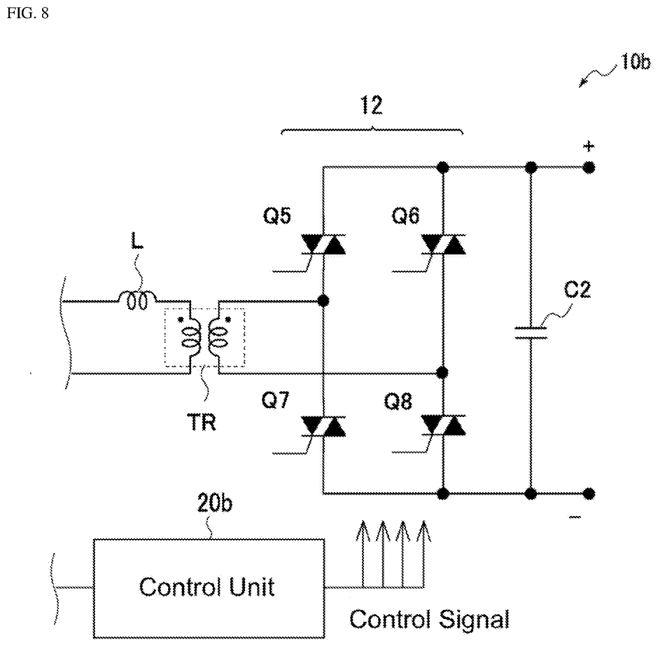

FIG. 8 is a schematic view illustrating an isolated bidirectional DC-DC converter device according to a third embodiment.

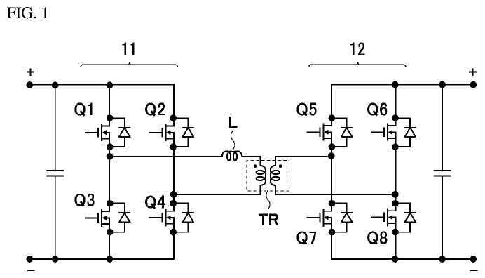

As illustrated in FIG. 8, an isolated bidirectional DC-DC converter device (also “third converter device” below) is provided with an isolated bidirectional DC-DC converter circuit 10b and a control unit 20b. The isolated bidirectional DC-DC converter circuit 10b replaces the second full-bridge inverter circuit 12 in the isolated bidirectional DC-DC converter circuit 10 (FIG. 1) with a full-bridge inverter circuit made up of four bidirectional switching elements Q5−Q8. Note that while a TRIAC is depicted for each of the bidirectional switching elements making up the second full-bridge inverter circuit 12 in FIG. 8, a bidirectional switching element besides a TRIAC may be used (e.g., a bidirectional switching element where unidirectional switching elements have an inverse-parallel connection).

Similar to the control unit 20 in the first converter device (i.e., the isolated bidirectional DC-DC converter device according to the first embodiment), the control unit 20b causes the first full-bridge inverter circuit 11 side (not shown) of the isolated bidirectional DC-DC converter circuit 10b to function as a primary side boost circuit, and the second full-bridge inverter circuit 12 side to function as a primary side buck circuit.

Before describing the particulars of the control unit 20b controlling the isolated bidirectional DC-DC converter circuit 10b , the issues that conventionally arise in the isolated bidirectional DC-DC converter circuit 10b when it is made to perform a boosting operation is described.

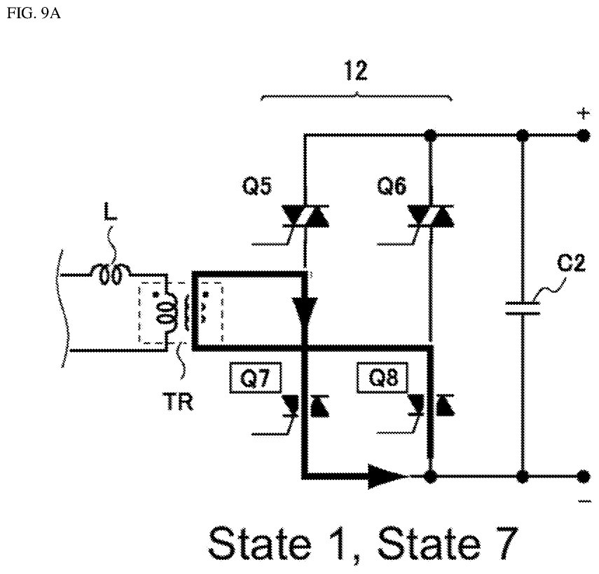

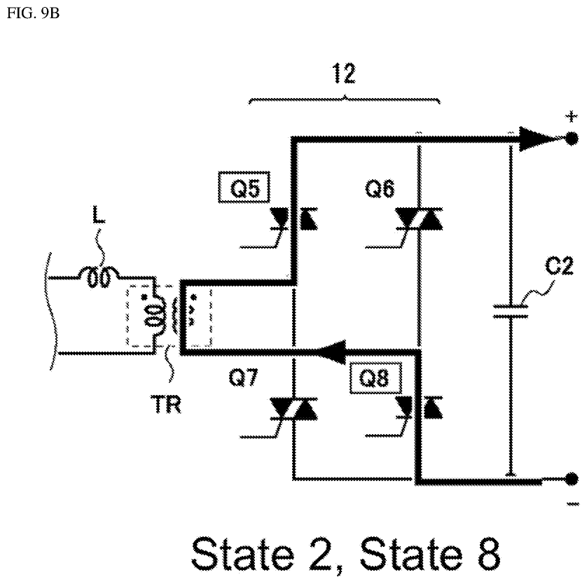

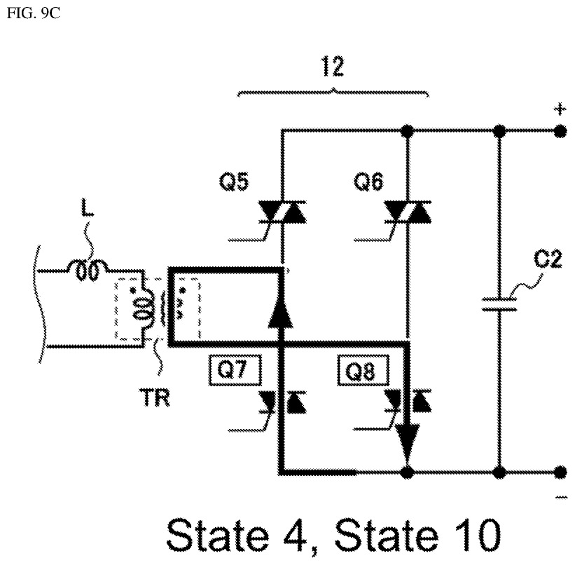

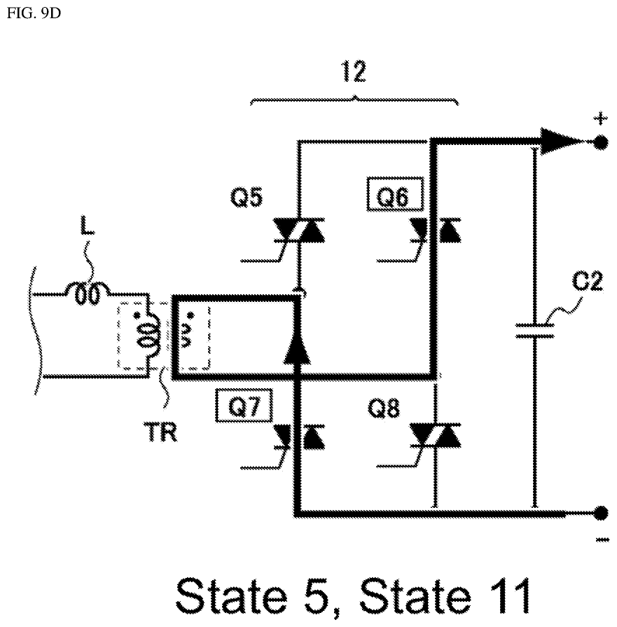

To this point, when an isolated bidirectional DC-DC converter circuit 10b is made to perform a boosting operation, the bidirectional switching elements Q5−Q8 are controlled so that the current path of the second full-bridge inverter circuit 12 enters each of the states depicted in FIGS. 9A, 9B, 9C, 9D. The labels “State n” (e.g., State 1, State 2, and the like) shown at the lower part of each of the current path diagrams in FIGS. 9A, 9B, 9C, 9D are states that correspond to the “State n” in FIG. 4. More precisely, the “State n” in FIG. 4, and the ON and OFF states of the switching elements Q1−Q4 and the status of IL (rising, falling) are the same state.

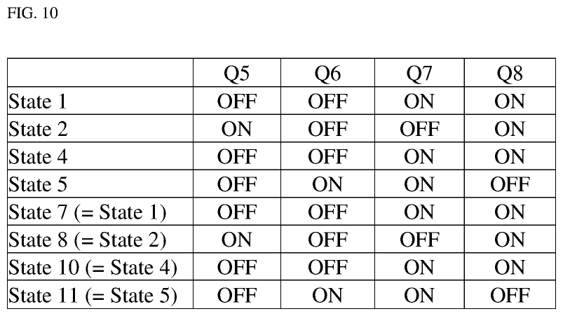

That is, conventionally when the isolated bidirectional DC-DC converter circuit 10b is made to perform a boosting operation, the circuit is controlled so that each of the states 1, 2, 4, 5 are identical to the states 7, 8, 10, 11 and the bidirectional switching elements Q5−Q8 are controlled to ON and OFF states as illustrated in FIG. 10.

When this type of control is performed, as is clear from FIG. 10, the time that each of the low-side switching elements Q7, Q8 (bidirectional switching elements Q7, Q8) are set to on is longer than the time that each of the high-side switching elements Q5, Q6 (bidirectional switching elements Q5, Q6) are set to on. Therefore, when the isolated bidirectional DC-DC converter circuit 10b is made to perform a boosting operation via the traditional control method, the temperature of the low-side switching elements tends to increase, which results in restricting the conditions under which the isolated bidirectional DC-DC converter circuit 10b is allowed to continue to operate at the temperature of the low-side switching elements.

The particulars of control of the isolated bidirectional DC-DC converter circuit 10b by the control unit 20b is described below.

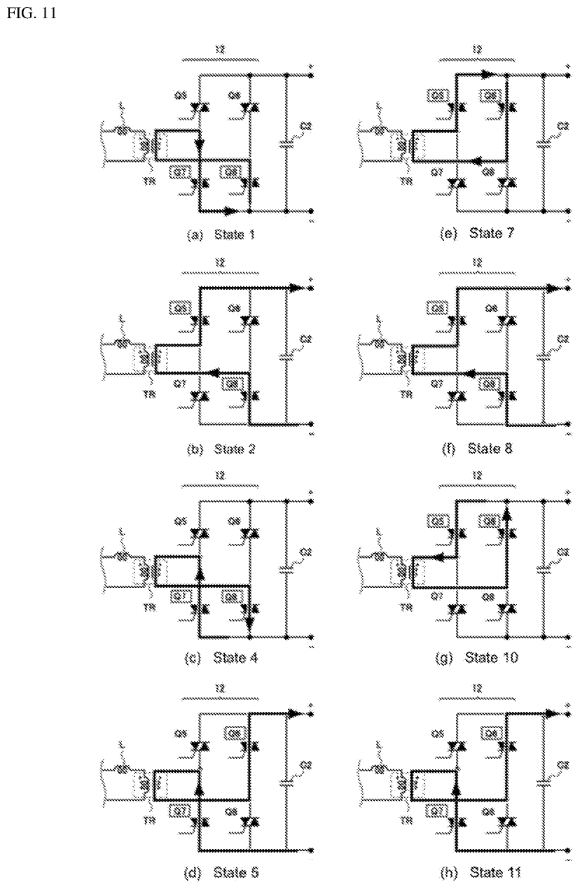

To address the above-mentioned problem, the control unit 20b in the third converter device is configured to actuate the bidirectional switching elements Q5−Q8 so that the current path in the second full-bridge inverter circuit 12 in each state is as illustrated in FIG. 11 when the isolated bidirectional DC-DC converter circuit 10b is made to perform a boost operation. The label “State n” at the lower part of the current path diagrams in FIG. 11 correspond to the “State n” in FIG. 4, similarly to FIGS. 9A, 9B, 9C, 9D.

That is, the control unit 20b is configured to alternate between the following two actuates. A first control (FIGS. 11(a)-11(d)) that actuates the bidirectional switching elements Q5−Q8 so that when current circulates in the second full-bridge inverter circuit 12, the aforementioned current passes through the bidirectional switching element Q7, and the bidirectional switching element Q8 to thereby rectify the output of the transformer TR; and a second control (FIGS. 11(e)-11(f)) that actuates the bidirectional switching elements so that when current circulates in the second full-bridge inverter circuit 12, the aforementioned current passes through the bidirectional switching element Q5, and the bidirectional switching element Q6 to thereby rectify the output of the transformer TR.

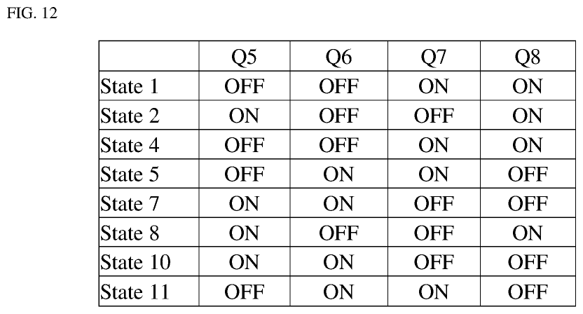

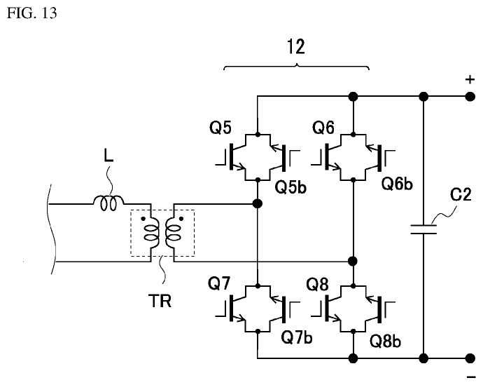

FIG. 12 depicts the ON and OFF states of the bidirectional switching elements Q5-Q8 in each of the states illustrated as the current paths in FIG. 11. As is clear from FIG. 12, alternating between performing the first control and the second control (i.e., if the current path in the second full-bridge inverter circuit 12 is controlled as illustrated in FIG. 11) the time that the low-side switching elements (bidirectional switching elements Q7, Q8) are set to on matches the time that the high-side switching elements (bidirectional switching elements Q5, Q6) are set to on.

Accordingly, the temperature of the bidirectional switching elements in the second full-bridge inverter circuit 12 of the isolated bidirectional DC-DC converter device according to this embodiment increases uniformly to a large extent when the isolated bidirectional DC-DC converter circuit 10b performs a boost operation. As a result, the isolated bidirectional DC-DC converter device according to the embodiment may function under a wider range of conditions that make continuous operation possible (i.e., range of the boost ratio, and the like) compared to the traditional isolated bidirectional DC-DC converter device.

Possible Modifications

An isolated bidirectional DC-DC converter device according to the above described embodiments may be given various modifications. The control unit 20 in the isolated bidirectional DC-DC converter device according to the first embodiment may be modified to perform the first control and the second control M times each (M≤2). The control unit 20 in the isolated bidirectional DC-DC converter device according to the second embodiment may be modified to execute the first control and the second control in an order different from the above described sequence, so that the execution rate of the first control is a target value. The control unit 20b in the isolated bidirectional DC-DC converter device according to the third embodiment may be given a function of modifying the execution rate of the first control so that the temperature T1 of the low-side switching elements is substantially the same as the temperature T2 of the high-side switching elements.

The isolated bidirectional DC-DC converter device according to the first and second embodiments may be further modified as follows. (1) The second full-bridge inverter circuit 12 may be modified and configured as the circuit illustrated in FIG. 8; in other words, the second full-bridge inverter circuit 12 may be made up of switching elements Q5−Q8 in inverse-parallel connection with switching elements Q5b−Q8b respectively. Note that while FIG. 8 illustrates a second full-bridge inverter circuit 12 where each of the switching elements is an IGBT, each of the switching elements may be another type of semiconductor switch (e.g., a MOSFET, or the like). The switching elements Q5b−Q8b may be bidirectional switching elements such as a TRIAC (a bidirectional triode thyristor), or the like. (2) The control unit 20 may be modified to actuate the switching elements Q5b−Q8b to ON and OFF so that during a boost operation, in addition to the above described control (a control of selectively carrying out the first control and the second control), the current path of the second full-bridge inverter circuit 12 in each of the states, State 1 through State 12 (FIG. 4), match the states illustrated in FIG. 5.

In general, the loss when current flows through the switching element Q5b is less than the loss of the same current traveling through a diode; therefore, an isolated bidirectional DC-DC converter device with an even greater conversion rate can be obtained if each of the embodiments of the isolated bidirectional DC-DC converter device is modified as above described.

### REFERENCE NUMERALS

10, 10b Isolated bidirectional DC-DC converter circuit
11 First full-bridge inverter circuit
12 Second full-bridge inverter circuit
20, 20b Control Unit
31, 32 Temperature sensor

1. An isolated bidirectional DC-DC converter device comprising:
a first full-bridge inverter circuit comprising first through fourth switching elements;
a second full-bridge inverter circuit connected to the first full-bridge inverter circuit via a transformer; the second full-bridge inverter circuit comprising a fifth switching element and a sixth switching element which are high-side switching elements and a seventh switching element and an eighth switching element which are low-side switching elements; and
a control unit configured to repeatedly execute an input-side control and an output-side control while boosting an input voltage to the first full-bridge inverter circuit, wherein the input-side control actuates the switching elements in the first full-bridge inverter circuit and the output-side control actuates the fifth through eighth switching elements in the second full-bridge inverter circuit synchronously with each input-side control, wherein
the control unit selectively executes any of a first control and a second control as the output-side control where the first control maintains the fifth switching element and the sixth switching element in an OFF state while alternating the seventh switching element and the eighth switching element between ON and OFF states;
and the second control maintains the seventh switching element and the eighth switching element in the OFF state while alternating the sixth switching element and the fifth switching element between the ON and OFF states.

2. The isolated bidirectional DC-DC converter device according to claim 1, wherein the control unit alternates between executing the first control and the second control as the output-side control.

3. The isolated bidirectional DC-DC converter device according to claim 1, wherein
the control unit acquires a temperature T1 of the seventh and eighth switching elements, and a temperature T2 of the fifth and sixth switching elements,
in response to T1−T2 being greater than or equal to a first predetermined value greater than or equal to zero, the control unit decreases a first control execution rate which is the rate at which the first control is performed as the output-side control, and
in response to T1−T2 being less than a second predetermined value that is less than or equal to zero, the control unit increases the first control execution rate.

4. A control method for an isolated bidirectional DC-DC converter circuit including a first full-bridge inverter circuit that includes first through fourth switching elements and a second full-bridge inverter circuit connected to the first full-bridge inverter circuit via a transformer, the second full-bridge inverter circuit including a fifth switching element and sixth switching element which are high-side switching elements, and a seventh switching element and an eighth switching element which are low-side switching elements, and the control method comprising:
periodically executing an input-side control and an output-side control while boosting an input voltage to the first full-bridge inverter circuit, wherein the input-side control actuates the switching elements in the first full-bridge inverter circuit, and the output-side control actuates the fifth through eighth switching elements in the second full-bridge inverter circuit in the case of boosting the input voltage to the first full-bridge inverter circuit; and
selectively executing any of a first control and a second control as the output-side control where the first control maintains the fifth switching element and the sixth switching element in an OFF state while alternating the seventh switching element and the eighth switching element between ON and OFF states, and the second control maintains the seventh switching element and the eighth switching element in the OFF state while alternating the sixth switching element and the fifth switching element between the ON and OFF states.

5. An isolated bidirectional DC-DC converter device comprising:
a first full-bridge inverter circuit comprising first through fourth switching elements;
a second full-bridge inverter circuit having a first leg and a second leg and connected to the first full-bridge inverter circuit via a transformer; the second full-bridge inverter circuit comprising a fifth bidirectional switching element and a sixth bidirectional switching element which are high-side switching elements, and a seventh bidirectional switching element and an eighth bidirectional switching element as a low-side switching elements; and
a control unit configured to repeatedly execute an input-side control and an output-side control while boosting an input voltage to the first full-bridge inverter circuit, wherein the input-side control actuates the switching elements in the first full-bridge inverter circuit and the output-side control actuates the fifth through eighth bidirectional switching elements in the second full-bridge inverter circuit synchronously with each input-side control, wherein
the control unit is configured to selectively execute any of a first control and a second control as the output-side control, wherein the first control actuates the fifth through eighth bidirectional switching elements so that while a current circulates in the second full-bridge inverter circuit, the current passes through the seventh bidirectional switching element and the eighth bidirectional switching element to thereby rectify an output of the transformer; and the second control actuates the fifth through eighth bidirectional switching elements so that while a current circulates in the second full-bridge inverter circuit, the current passes through the fifth bidirectional switching element and the sixth bidirectional switching element to rectify the output of the transformer.

6. A control method for an isolated bidirectional DC-DC converter including a first full-bridge inverter circuit that includes first through fourth switching elements and a second full-bridge inverter circuit having a first leg and a second leg and connected to the first full-bridge inverter circuit via a transformer, the second full-bridge inverter circuit including a fifth switching element and sixth switching element which are high-side switching elements, and a seventh switching element and an eighth switching element which are low-side switching elements, and the control method comprising:
periodically executing an input-side control and an output-side control while boosting an input voltage to the first full-bridge inverter circuit, wherein the input-side control actuates the switching elements in the first full-bridge inverter circuit and the output-side control actuates the fifth through eighth bidirectional switching elements in the second full-bridge inverter circuit while boosting the input voltage sent to the first full-bridge inverter circuit; and
selectively execute any of a first control and a second control as the output-side control, wherein the first control actuates the fifth through eighth bidirectional switching elements so that while a current circulates in the second full-bridge inverter circuit, the current passes through the seventh bidirectional switching element and the eighth bidirectional switching element to thereby rectify an output of the transformer; and the second control actuates the fifth through eighth bidirectional switching elements so that while a current circulates in the second full-bridge inverter circuit, the current passes through the fifth bidirectional switching elements to rectify the output of the transformer.

7. The isolated bidirectional DC-DC converter device according to claim 2, wherein
the control unit acquires a temperature T1 of the seventh and eighth switching elements, and a temperature T2 of the fifth and sixth switching elements,
in response to T1−T2 being greater than or equal to a first predetermined value greater than or equal to zero, the control unit decreases a first control execution rate which is the rate at which the first control is performed as the output-side control, and
in response to T1−T2 being less than a second predetermined value that is less than or equal to zero, the control unit increases the first control execution rate.
